(19) United States
(12) Patent Application Publication
(10) Pub. No.: US 2002/0183466 A1
(43) Pub. Date: Dec. 5, 2002

(54) Solution polymerization process with dispersed catalyst activator

(76) Inventors: Edmund M. Carnahan, Fresno, TX (US); Alexander Vogel, Houston, TX (US); Daniel D. VanderLende, Sugar Land, TX (US); James C. Stevens, Richmond, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/126,774

(22) Filed: Apr. 19, 2002

Related U.S. Application Data
(60) Provisional application No. 60/287,485, filed on Apr. 30, 2001.

(51) Int. Cl. C08F 4/44

(52) U.S. Cl. 526/153; 526/348.2

(57) ABSTRACT

A process for polymerization of an olefin comprising contacting one or more olefins, optionally in the presence of an inert aliphatic, alicyclic or aromatic hydrocarbon, with a catalyst system comprising a Group 3-10 metal complex, a dispersible clay catalyst activator comprising finely divided clay having a correlated settling rate less than 0.03 cm/sec, and from 0.001 to 10 mmol/g of clay of a Group 1 to 14 metal alkyl compound. The foregoing process is particularly adapted for use in the preparation of olefin polymers under solution polymerization conditions.

### CROSS REFERENCE STATEMENT

This application claims the benefit of U.S. Provisional Application No. 60/287,485, filed Apr. 30, 2001.

### BACKGROUND OF THE INVENTION

The present invention relates to a catalyst activator. More particularly the present invention relates to dispersed catalyst activators particularly adapted for use in a solution polymerization process for polymerization of α-olefins. Such an activator is particularly advantageous for use in a continuous solution polymerization process wherein catalyst, catalyst activator, and at least one polymerizable monomer are continuously added to a reactor operating under solution polymerization conditions, and polymerized product is continuously removed therefrom.

It is previously known in the art to activate Ziegler-Natta polymerization catalysts, particularly such catalysts comprising Group 4 metal complexes containing delocalized π-bonded ligand groups by the use of finely divided substrates, including clays, containing Brønsted acid salts capable of transferring a proton to form a cationic derivative of such Group 4 metal complexes. Preferred Brønsted acid salts are such compounds containing a noncoordinating anion that are capable of stabilizing the resulting Group 4 metal cation, especially tetrakis(pentafluorophenyl)-borate Preferred cocatalysts comprised substrate materials having a correlated settling rate less than 0.03 cm/sec, and from 0.001 to 10 mmol/g of an ionic catalyst activator deposited thereon. The foregoing process was disclosed in US-A-5,883,204.

We have now discovered that certain acidic clay materials may suitably activate metal complexes without the presence of the forgoing ionic catalyst activator. Accordingly, there is now provided a new form of catalyst activator that is particularly adapted for use in a continuous solution polymerization reaction where controlled, metered addition of specific quantities of such activator is required.

### SUMMARY OF THE INVENTION

According to the present invention there is now provided a process for polymerization of an olefin comprising contacting one or more olefins, in the presence of an inert aliphatic, alicyclic or aromatic hydrocarbon, with a catalyst system comprising one or more Group 3-10 metal complexes, a dispersible clay catalyst activator comprising finely divided clay having a correlated settling rate less than 0.03 cm/sec, and optionally from 0.001 to 10 mmol/g of clay of Group 1 to 14 metal compound containing at least one alkyl group of up to 20 carbons, or an alumoxane. The foregoing process is particularly adapted for use in the preparation of olefin polymers under solution polymerization conditions.

### DETAILED DESCRIPTION OF THE INVENTION

The term “correlated settling rate” as used herein is the terminal velocity, Vₜ of a spherical particle falling under the action of gravity through a viscous suspending medium. It may be calculated according to Stokes Law (Stokes, G. G., Trans, Cambridge Philos. Soc. 9(II), 8, (1951)) as follows:

Vₜ=((pₛ-p)gdₚ²)/18μₛtm (1)

where:

pₛis the apparent density of the solid in g/cm³,

p is the true density of the suspending medium in g/cm³, both pₛ and p being measured at 25° C.,

g is the gravitational constant (980.665 cm/sec²),

dp is the particles diameter in cm, and

μₛ is the viscosity of the mixture of particles and suspending medium in g/cm/sec.

The viscosity of the mixture of particles and suspending medium is correlated with the viscosity of the suspending medium itself and its volume fraction by means of equation 2 (Brown, G. G., Principles of Unit Operations, Foust, A. S., Ed., John Wiley and Sons, New York, 1950, Chap 18):

μ_{s/}μ=10^{1.82(1-x)/x} (2)

where:

μis the suspending medium's viscosity in g/cm/sec, and

X is the medium's volume fraction (for example 0.99 for a 1 volume percent suspension).

For example, using the foregoing equations with a typical mixed alkanes suspending medium (Isopar™E, available from Exxon Chemical Company, a 1 volume percent suspension, and a 15 μm particle having a density of 2.300 g/cm³,p=0.7200 g/cm³, μ=0.0063 g/cm/sec), (μₛ=0.0067 g/cm/sec). The correlated settling rate is 0.029 cm/sec. The corresponding value for a 5 nm particle having a density of 1.510 g/cm³, would be 1.6×10^{31 9} cm/sec.

The correlated settling rate of a particle can also be experimentally derived by measuring the subsidence of the upper phase boundary of a well dispersed suspension of such particles over time. The correlated settling rate is then calculated by a least squares regression of the linear slope of a plot of such subsidence as a function of time. Preferred for use herein are clays in the form of particles having a correlated settling rate from 0.01 to 1×10^{31 10}(cm/sec, more preferably from 1.0×10⁻⁴ to 1×10^{31 10} cm/sec.

In order to be readily dispersible in the inert diluent employed, the clay material should be fractionated into as small a particle size as possible. Preferred particle sizes of the clays range from 5.0 nm to 15 μm (5×10⁹ to 1.5×10⁻⁵ m), more preferably from 0.1 to 15 μm (1×10⁻⁷ to 1.5×10−5 m), and most preferably from 0.7 to 5 μm (7×10⁻⁶ to 5×10−5 m). Particle size when used herein refers to the median volume average particle distribution measured by laser particle size analysis or similar technique.

Suitable clay materials preferably have a surface area as determined by nitrogen porosimetry using the B.E.T. method from 0.01 to 1000 m²/g, and preferably from 1 to 600 m²/g. The pore volume of the substrate, as determined by nitrogen adsorption, advantageously is between 0.001 and 3 cm³/g, preferably from 0.01 to 2 cm³/g. Further desirably, the clay has a bulk density greater than about 0.1 g/mL, preferably greater than about 0.2 g/mL.

Any natural or synthetic clay may be used in the invention. Preferred clay materials are smectite clays, including montmorillonite, bidelite, saponite and hectorite or fluoromagnesium silicate. A most preferred clay is montmorillonite clay. Mixtures of the foregoing clays as well as mixtures thereof with inorganic silicates, such as sodium silicate, silica, or similar material may also be used. Prior to contacting with the organometallic compound the clay may be heated to remove residual water. Typical heat treatments (calcining) are carried out at a temperature from 150 to 900° C., preferably 250 to 850° C. for a duration of 10 minutes to 50 hours. The clay or treated clay may be acid exchanged to replace at least a portion of native alkali metal cations or alkaline earth metal cations, especially sodium or magnesium cations, with H³⁰ cations or Brønsted acid salts, particularly ammonium salts of noncoordinating anions, such as trimethylammonium tetrakis(pentafluorophenyl)borate or methyldioctadecylammonium tetrakis(pentafluorophenyl)-borate, if desired.

By reacting the clay or clay derivative with an organometallic compound (passivating), it is believed that residual hydroxyl or other polar functionality of the clay is substantially reduced or removed by capping or reacting such groups with the organometallic compound. Preferably, the clays are passivated for use herein. Suitably, a stoichiometric excess of organometallic compound compared to residual hydroxyl or other polar groups on the surface of the clay is employed. Desirably, the residual surface hydroxyl or other reactive functionality content of the clay is reduced to a level of less than 0.1 weight percent, preferably less than 0.01 weight percent of the treated clay composition. Residual hydroxyl functionality can be detected by the technique of Fourier Transform Infrared Spectroscopy (DRIFTS IR) as disclosed in Fourier Transform Infrared Spectroscopy, P. Griffiths & J. de Haseth, 83 Chemical Analysis, Wiley Interscience (1986), p. 544. Preferred organometallic compounds for use herein as passivating agents include alkali metal-,alkaline earth metal-and group 8-13 metal-hydrocarbyl compounds. Preferred organometallic compounds are trihydrocarbylaluminum compounds, preferably triethylaluminum, triisopropylaluminum or triisobutylaluminum.

In addition to the foregoing clay material, a group 1-14 metal alkyl compound or alumoxane may additionally be present in the catalyst composition. Such compound may be excess passivating agent or a specifically added tertiary component of the catalyst composition. Examples of suitable group 1-14 metal alkyl compounds are compounds of the formula (R)₃Al where each R, independently each occurrence is selected from the group consisting of alkyl, aryl, amide, halogen, alkoxide, oxide, mercaptide, siloxane, or phosphide or up to 20 atoms not counting hydrogen, with the proviso that in at least one occurrence R is alkyl. Preferred group 1-14 metal alkyl compounds are trialkyl aluminum or dialkylzinc compounds especially triethylaluminum, tri(isopropyl)aluminum or tri(n-butylaluminum). A preferred alumoxane is methylalumoxane.

The clay containing catalyst composition is added to the solution polymerization in a controlled manner by dispersing the same in a non-solvent liquid and pumping or metering the resulting liquid/solid dispersion. Desirable non-solvent liquids are the aliphatic or alicyclic hydrocarbons used in the polymerization reaction. Preferred non-solvent liquids comprise C₄₋₁₀ aliphatic, alicyclic, or aromatic hydrocarbons, including mixtures thereof. The solid dispersion of clay activator is readily dispersed in the liquid non-solvent by any suitable technique, especially by use of agitation or sonic energy. Typically, a vessel is maintained in an agitated state containing the desired solid dispersion and the non-solvent while a pump or other delivery means removes the liquid/solid dispersion and injects it into the reactor at the desired delivery rate.

The dispersed clay activator may be directly added to the polymerization reactor and subsequently contacted with a Group 3-10 metal complex, especially a metallocene catalyst or it may be first contacted with the metal complex and the resulting mixture subsequently added to the polymerization reactor. The resulting combination of catalyst, dispersed clay cocatalyst and optional group 1- 14 metal alkyl compound or alumoxane is collectively referred to herein as a catalyst system or catalyst composition.

All references herein to elements or metals belonging to a certain Group refer to the Periodic Table of the Elements published and copyrighted by CRC Press, Inc., 1989. Also any reference to the Group or Groups shall be to the Group or Groups as reflected in this Periodic Table of the Elements using the IUPAC system for numbering groups.

Suitable metal complexes (also referred to as catalysts) for use herein include any compound of Groups 3-10 of the Periodic Table of the Elements capable of being activated to olefin insertion and polymerization by the present clay compositions. Preferably such complexes contain at least one ligand group bonded to the metal through delocalization of π-electrons or one or more pairs of unshared electrons thereof. Examples include Group 10 diimine derivatives corresponding to the formula:

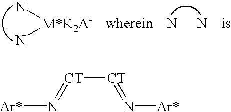

M* is Ni(II) or Pd(II);

K is hydrocarbyl;

Ar* is an aryl group, especially 2,6-diisopropylphenyl, 2,6-dimethylphenyl,2,6-di-t-butylphenyl, or 2,6-diphenylphenyl; and

T independently each occurrence is selected from the group consisting of hydrogen, C₁₋₄ alkyl or phenyl, or two T groups together with the two carbon moieties form a fused ring system, especially a 1,8-naphthanediyl group .

Certain of the foregoing catalysts are disclosed by M. Brookhart, et al., in J. Am. Chem. Soc., 118,267-268 (1996) and J. Am. Chem. Soc., 117, 6414 -6415 (1995), as being active polymerization catalysts especially for polymerization of α-olefins, either alone or in combination with polar comomoners such as alkyl acrylates and alkyl methacrylates. In an embodiment of the present invention it has now been discovered that the foregoing catalysts also are effective for use in the polymerization of vinyl chloride monomer.

Additional catalysts include derivatives of Group 3,4,5,6,7,8, or 9, or Lanthanide metals which are in the +2,+3, or +4 formal oxidation state. Preferred compounds include metal complexes containing from 1 to 3 π-bonded anionic or neutral ligand groups, which may be cyclic or non-cyclic delocalized π-bonded anionic ligand groups. Exemplary of such π-bonded anionic ligand groups are conjugated or nonconjugated, cyclic or non-cyclic dienyl groups, allyl groups, boratabenzene groups, and arene groups. By the term “π-bonded” is meant that the ligand group is bonded to the transition metal by means of electrons participating in the delocalized π-bond of the ligand.

Each atom in the delocalized π-bonded group may independently be substituted with a radical selected from the group consisting of hydrogen, halogen, hydrocarbyl, halohydrocarbyl, hydrocarbyl-substituted metalloid radicals wherein the metalloid is selected from Group 14 of the Periodic Table of the Elements, and such hydrocarbyl- or hydrocarbyl-substituted metalloid radicals further substituted with a Group 15 or 16 hetero atom containing moiety. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. In addition two or more such radicals may together form a fully or partially saturated fiused ring system, an unsaturated fused ring system, or a metallocycle with the metal. Suitable hydrocarbyl-substituted organo-metalloid radicals include mono-, di- and tri-substituted organometalloid radicals of Group 14 elements wherein each of the hydrocarbyl groups contains from 1 to 20 carbon atoms. Examples of suitable hydrocarbyl-substituted organometalloid radicals include trimethylsilyl, triethylsilyl, ethyldimethylsilyl, methyldiethylsilyl, triphenylgermyl, and trimethylgermyl groups. Examples of Group 15 or 16 hetero atom containing moieties include amine, phosphine, ether or thioether moieties or divalent derivatives thereof, e. g. amide, phosphide, ether or thioether groups bonded to the transition metal or Lanthanide metal, and bonded to the hydrocarbyl group or to the hydrocarbyl-substituted metalloid containing group.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, and boratabenzene groups, as well as C₁₋₁₀ hydrocarbyl-substituted or C₁₋₁₀ hydrocarbyl-substituted silyl substituted derivatives thereof. Preferred anionic delocalized π-bonded groups are cyclopentadienyl, pentamethylcyclopentadienyl, tetramethylcyclopentadienyl, tetramethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, and tetrahydroindenyl.

The boratabenzenes are anionic ligands which are boron containing six membered ring systems. They are previously known in the art having been described by G. Herberich, et al., in Organometallics, 14,1, 471-480 (1995). They may be prepared by reaction of tin hexadiene compounds and a borontrihalide followed by substitution with a hydrocarbyl, silyl or germyl group. Such groups correspond to the formula:

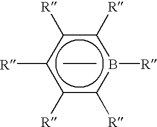

wherein R″ is selected from the group consisting of hydrocarbyl, silyl, or germyl, said R″ having up to 50, preferably up to 20 non-hydrogen atoms. In complexes involving divalent derivatives of such groups, R″ is a covalent bond or a divalent derivative of one of the foregoing groups, which is also bonded to another atom of the complex thereby forming a bridged system.

A suitable class of catalysts are transition metal complexes corresponding to the formula:

LₗMXₘX′ₙX″ₚ, or a dimer thereof

wherein:

L is an anionic, delocalized, π-bonded group that is bound to M, containing up to 50 non-hydrogen hydrogen atoms, optionally two L groups may be joined together forming a bridged structure, and further optionally one L may be bound to X, or even further optionally one L may be bound to X′;

M is a metal of Group 4 of the Periodic Table of the Elements in the +2,+3 or +4 formal oxidation state;

X is an optional, divalent substituent of up to 50 non-hydrogen atoms that together with L forms a metallocycle with M;

X′ is an optional neutral ligand having up to 20 non-hydrogen atoms;

X″ each occurrence is a monovalent, anionic moiety having up to 40 non-hydrogen atoms, optionally, two X″ groups may be covalently bound together forming a divalent dianionic moiety having both valences bound to M, or, optionally 2 X″ groups may be covalently bound together to form a neutral, conjugated or nonconjugated diene that is π-bonded to M (whereupon M is in the +2 oxidation state), or further optionally one or more X″ and one or more X′ groups may be bonded together thereby forming a moiety that is both covalently bound to M and coordinated thereto by means of Lewis base functionality;

l is 0, or2;

m is 0 or 1;

n is a number from 0 to 3;

p is an integer from 0 to 3; and

the sum, l+m+p, is equal to the formal oxidation state of M, except when 2 X″ groups together form a neutral conjugated or non-conjugated diene that is π-bonded to M, in which case the sum l+m is equal to the formal oxidation state of M.

Preferred complexes include those containing either one or two L groups. The latter complexes include those containing a bridging group linking the two L groups. Preferred bridging groups are those corresponding to the formula (ER*₂)ₓ wherein E is silicon, germanium, tin, or carbon, R* independently each occurrence is hydrogen or a group selected from silyl, hydrocarbyl, hydrocarbyloxy and combinations thereof, said R* having up to 30 carbon or silicon atoms, and x is 1 to 8. Preferably, R* independently each occurrence is methyl, ethyl, propyl, benzyl, tert-butyl, phenyl, methoxy, ethoxy or phenoxy. Preferably, x is 1 or 2.

Examples of the complexes containing two L groups are compounds corresponding to the formula:

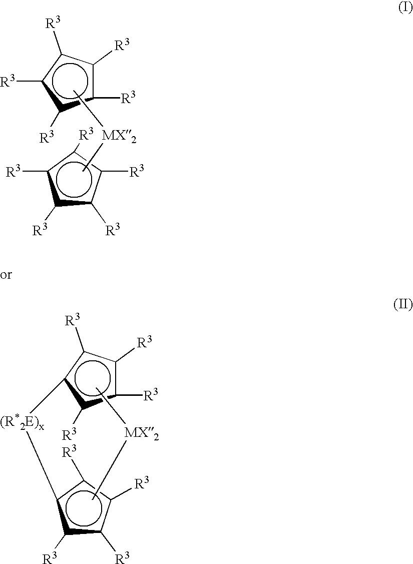

wherein:

M is titanium, zirconium or hafnium, preferably zirconium or hafnium, in the +2 or +4 formal oxidation state;

R³ in each occurrence independently is selected from the group consisting of hydrogen, hydrocarbyl, hydrocarbyloxy, silyl, germyl, cyano, halo and combinations thereof, (especially, hydrocarbyloxysilyl, halocarbyl, and halohydrocarbyl) said R³ having up to 20 non-hydrogen atoms, or adjacent R³ groups together form a divalent derivative (that is, a hydrocarbadiyl, siladiyl or germadiyl group) thereby forming a fused ring system, and

X″ independently each occurrence is an anionic ligand group of up to 40 non-hydrogen atoms, or two X″ groups together form a divalent anionic ligand group of up to 40 non-hydrogen atoms or together are a conjugated diene having from 4 to 30 non-hydrogen atoms forming a π-complex with M, whereupon M is in the +2 formal oxidation state, and

R*, E and x are as previously defined.

The foregoing metal complexes are especially suited for the preparation of polymers having stereoregular molecular structure. In such capacity it is preferred that the complex possesses C_{S} symmetry or possesses a chiral, stereorigid structure. Examples of the first type are compounds possessing different delocalized π-bonded systems, such as one cyclopentadienyl group and one fluorenyl group. Similar systems based on Ti(IV) or Zr(IV) were disclosed for preparation of syndiotactic olefin polymers in Ewen, et al., J. Am. Chem. Soc. 110, 6255-6256 (1980). Examples of chiral structures include rac bis-indenyl complexes. Similar systems based on Ti(IV) or Zr(IV) were disclosed for preparation of isotactic olefin polymers in Wild et al., J. Organomet. Chem., 232, 233-47, (1982).

Exemplary bridged ligands containing two π-bonded groups are: (dimethylsilyl-bis (cyclopentadienyl)), (dimethylsilyl-bis(methylcyclopentadienyl)), (dimethylsilyl-bis (ethylcyclopentadienyl)), (dimethylsilyl-bis(t-butylcyclopentadienyl)), (dimethylsilyl-bis (tetramethylcyclopentadienyl)), (dimethylsilyl-bis(indenyl)), (dimethylsilyl-bis (tetrahydroindenyl)), (dimethylsily-bis(fluorenyl)), (dimethylsilyl-bis(tetrahydrofluorenyl)), (dimethylsilyl-bis(2-methyl-4-phenylindenyl)), (dimethylsilyl-bis(2-methylindenyl)), (dimethylsilyl-cyclopentadienyl-fluorenyl), (dimethylsilyl-cyclopentadienyl-octahydrofluorenyl), (dimethylsilyl-cyclopentadienyl-tetrahydrofluorenyl), (1, 1, 2, 2-tetramethyl-1, 2-disilyl-bis-cyclopentadienyl), (1,2-bis (cyclopentadienyl)ethane, and (isopropylidene-cyclopentadienyl-fluorenyl).

Preferred X″ groups are selected from hydride, hydrocarbyl, silyl, gennyl, halohydrocarbyl, halosilyl, silylhydrocarbyl and aminohydrocarbyl groups, or two X″ groups together form a divalent derivative of a conjugated diene or else together they form a neutral, π-bonded, conjugated diene. Most preferred X″ groups are C₁₋₂₀ hydrocarbyl groups.

A further class of metal complexes utilized in the present invention corresponds to the preceding formula LₗMXₘX′ₙX″ₚ, or a dimer thereof, wherein X is a divalent substituent of up to 50 non-hydrogen atoms that together with L forms a metallocycle with M, or wherein one X′ is bound to both L and M.

Preferred divalent X substituents include groups containing up to 30 non-hydrogen atoms comprising at least one atom that is oxygen, sulfur, boron or a member of Group 14 of the Periodic Table of the Elements directly attached to the delocalized π-bonded group, and a different atom, selected from the group consisting of nitrogen, phosphorus, oxygen or sulfur that is covalently bonded to M.

A preferred class of such Group 4 metal coordination complexes used according to the present invention corresponds to the formula:

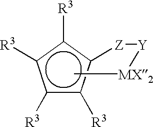

wherein:

M is titanium or zirconium in the +2 or +4 formal oxidation state;

R³ in each occurrence independently is selected from the group consisting of hydrogen, hydrocarbyl, silyl, germyl, cyano, halo and combinations thereof, said R³ having up to 20 non-hydrogen atoms, or adjacent R³ groups together form a divalent derivative (that is, a hydrocarbadiyl, siladiyl or germadiyl group) thereby forming a fused ring system,

each X″ is a hydride, hydrocarbyl, hydrocarbyloxy or silyl group, said group having up to 20 non-hydrogen atoms, or two X″ groups together form a neutral C₅₋₃₀ conjugated diene or a divalent derivative thereof;

Y is -O-, -S-, -NR*-, -PR*-; and

Z is SiR*₂, CR*₂, SiR*₂SiR*₂, CR*₂CR*₂, CR*=CR*, CR*₂SiR*₂, SnR*_{2,} or GeR*₂, wherein R* is as previously defined.

A further preferred class of Group 4 metal coordination complexes used according to the present invention wherein one X′ (illustrated by Z-Y′) is bound to both L and M correspond to the formula:

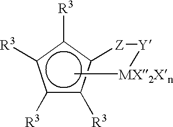

wherein:

M is titanium in the +3 formal oxidation state;

R³ each occurrence is independently selected from the group consisting of hydrogen, hydrocarbyl, silyl, germyl, cyano, halo and combinations thereof, said R³ having up to 20 non-hydrogen atoms, or adjacent R³ groups together form a divalent derivative (that is a hydrocarbadiyl, siladiyl or germadiyl group) thereby forming a fused ring system;

each X″ is a hydrocarbyl, hydrocarbyloxy or silyl group, said group having up to 20 non-hydrogen atoms;

Y′is -OR*, -SR*, -NR*_{2,} -PR₂;

Z is SiR*₂, CR*₂, SiR*₂SiR*₂, CR*₂CR*₂, CR*=CR*, CR*₂SiR*₂, SnR*₂,or GeR*_{2,} wherein R* is as previously defined; and

n is a number from 0 to 3.

Illustrative Group 4 metal complexes that may be employed in the practice of the present invention include: cyclopentadienyltitanium trimethyl, cyclopentadienyltitanium triethyl, cyclopentadienyltitanium triisopropyl, cyclopentadienyltitanium triphenyl, cyclopentadienyltitanium tribenzyl, cyclopentadienyltitanium 2,4-dimethylpentadienyl, cyclopentadienyltitanium 2,4-dimethylpentadienyl•triethylphosphine, cyclopentadienyltitanium 2,4-dimethylpentadienyl•trimethylphosphine, cyclopentadienyltitanium dimethyl methoxide, cyclopentadienyltitanium dimethyl chloride, pentamethylcyclopentadienyltitanium trimethyl, indenyltitanium trimethyl, indenyltitanium triethyl, indenyltitanium tripropyl, indenyltitanium triphenyl, tetrahydroindenyltitanium tribenzyl, pentamethylcyclopentadienyltitanium triisopropyl, pentamethylcyclopentadienyltitanium tribenzyl, pentamethylcyclopentadienyltitanium dimethyl methoxide, pentamethylcyclopentadienyltitanium dimethyl chloride, bis(η⁵-2,4-dimethylpentadienyl)titanium, bis(η⁵-2,4-dimethylpentadienyl)titanium•trimethylphosphine, bis(η⁵-2,4-dimethylpentadienyl)titanium•triethylphosphine, octahydrofluorenyltitanium trimethyl, tetrahydroindenyltitanium trimethyl, tetrahydrofluorenyltitanium trimethyl, (tert-butylamido)(1,1-dimethyl-2,3,4,9,10-η-1,4,5,6,7,8-hexahydronaphthalenyl)dimethylsilanetitanium dimethyl,(tert-butylamido)(1,1,2,3-tetramethyl-2,3,4,9,10-η-1,4,5,6,7,8-hexahydronaphthalenyl)dimethylsilanetitanium dimethyl,(tert-xatydamido)(tetramethyl-η-cyclopentadienyi)dimethylsi,anctitanium dimethyl, (tert-butylamido)(tetramethy-η⁵-cyclopentadienyl)dimethylsilanetitanium dimethyl, (tert-butylamido)(tetramethyl-72 ⁵-cyclopendtadieny)dimethylimehlanetitanium dimethyl, (tert-butylamido)(tetramethyl-η⁵-cyclopentadienyl)- 1,2-ethanediyltitanium dimethyl, (tert-butylamido)(tetramethyl-η⁵-indenyl)dimethylsilanetitanium dimethyl, (tert-butylamido)(tetramethyl-η⁵-cyclopentadienyl)dimethylsilanetitanium (III) 2-(dimethylamino)benzl; (tert-butylamido)(tetramethyl-η⁵-cyclopentadienyl)dimethylsilanetitanium (III) allyl, (tert-butylamido)(tetramethyl-η⁵-cyclopentadienyl)dimethylsilanetitanlium (III) 2,4-dimethylpentadienyl, (tert-butylamido)(tetramethyl-η⁵-cyclopentadienyl)dimethylsilanctitanium (II) 1,4-diphenyl-1,3-butadiene, (tert-butylamido)(tetramethyl-η⁵-cyclopentadienyl)dimethylsilanetitanium (II) 1,3-pentadiene, (tert-butylamido)(2-methylindenyl)dimethylsilanetitanium (II)1,4-diphenyl- 1,3-butadiene, (tert-butylamido)(2-methylindenyl)dimethylsilanetitanium (II) 2,4-hexadiene, (tert-butylamido)(2-methylindenyl)dimethylsilanetitanium (IV) 2,3-dimethyl-1,3-butadiene, (tert-butylamido)(2-methylindenyl)dimethylsilanetitanium (IV) isoprene, (tert-butylamido)(2-methylindenyl)dimethylsilanetitanium (IV) 1,3-butadiene, (tert-butylamido)(2,3-dimethylindenyl)dimethylsilanetitanium (IV) 2,3-dimethyl- 1 ,3-butadiene, (tert-butylamido)(2,3-dimethylindenyl)dimethylsilanetitanium (IV) isoprene (tert-butylamido)(2,3-dimethylindenyl)dimethylsilanetitanium (IV) dimethyl (tert-butylamido)(2,3-dimethylindenyl)dimethylsilanetitanium (IV) dibenzyl (tert-butylamido)(2,3-dimethylindenyl)dimethylsilanctitanium (IV)1,3-butadiene (tert-butylamido)(2,3-dimethylindenyl)dimethylsilanetitanium (II)1,3-pentadiene, (tert-butylamido)(2,3-dimethylindenyl)dimethylsilanetitanium (IV)1,4-diphenyl-1,3-butadiene, (tert-butylamido)(2-methylindenyl)dimethylsilanetitanium (II)1,3-pentadiene, (tert-butylamido)(2-methylindenyl)dimethylsilanetitanium (IV) dimethyl, (tert-butylamido)(2-methylindenyl)dimethylsilanetitanium (IV) dibenzyl, (tertbutylamido)(2methyl4-phenylindenyl)dimethylsilanetitarnum (II) 1,4-diphenyl-1,3-butadiene, (tert-butylamido)(2-methyli-4-phenylindeny)dimethylsitantitanium (II)1,3-pentadiene, (tert-butylamido)(2-methyl4-phenylindenyl)dimethylsianetitanium (II) 2,4-hexadiene, (tert-butylamido)(tetramethylindη⁵cycopentadienyl)dimethylsilanetitanium (IV) 1,3-butadiene, (tert-butylamido)(tetramethyl-η⁵-cyclopentadienyl)dimethylsilanctitanium (IV) 2,3-dimethyl-1,3-butadiene, (tert-butylamido)(tetramethyl-η⁵-cyclopentadienyl)dimethylsilanetitanium (IV) isoprene, (tert-butylamido)(tetramethyl-η⁵-cyclopentadienyl)dimethylsilanetitanium (II) 1,4-dibenzyl-1,3-butadiene, (tert-butylamido)(tetramethyl-η⁵-cyclopentadienyl)dimethylsilanetitanium (II) 2,4-hexadiene, (tert-butylamido)(tetramethyl-η⁵-cyclopentadienyl)dimethylsilanetitanium (II) 3-methyl- 1,3-pentadiene, (tert-butylamido)(2,4-dimethylpentadien-3-yl)dimethylsilanetitanium dimethyl, (tert-butylamido)(6,6-dimethylcyclohexadienyl)dimethylsilanetitanium dimethyl, (tert-butylamido)( 1,1-dimethyl-2,3,4,9,10-η-1,4,5,6,7,8-hexahydronaphthalen-4-yl) dimethylsilanetitanium dimethyl, (tert-butylamido)( 1,1,2,3-tetramethyl-2,3,4,9,10-η-1,4,5,6,7,8- hexahydronaphthalen-4-yl) dimethylsilanetitanium dimethyl (tert-butylamido)(tetramethyl-η⁵-cyclopentadienyl)methylphenylsilanetitanium (IV) dimethyl, (tert-butylamido)(tetramethyl-η⁵-cyclopentadienyl)methylphenylsilanetitanium (II) 1,4-diphenyl-1,3-butadiene, 1-(tert-butylamido)-2-(tetramethyl-η⁵-cyclopentadienyl)ethanediyltitanium (IV) dimethyl, 1-(tert-butylamido)-2-(tetramethyl-η⁵-cyclopentadienyl)ethanediyltitanium (II) 1,4-diphenyl-1,3-butadiene, 1-(dimethylamine)-2-(tetramethyl-η⁵-cyclopentadienyl)ethanediyltitanium (III) dimethyl, 1-(dimethylamine)-2-(tetramethyl-η⁵-cyclopentadienyl)ethanediyltitanium (III) diallyl, 1-(dimethylamine)-2-(tetramethyl-η⁵-cyclopentadienyl)ethanediyltitanium (III) dibenzyl, 1-(diisobutylamine)-2-(tetramethyl-η⁵-cyclopentadienyl)ethanediyltitanium (III) dimethyl, 1-(diisopropylamine)-2-(tetramethyl-η⁵-cyclopentadienyl)ethanediyltitanium (III) dimethyl, 1-(methyphenyllaine)-2-(tetramethyl-η⁵-cyclopentadienyl)ethanediyltitanium (III) dimethyl, (dimethylamine)(tetramethyl-η⁵-cyclopentadienyl)dimethylsilyltitanium (III) dimethyl, (dimethylamine)(tetramethyl-η⁵-cyclopentadienyl)dimethylsityltitanium (III) diallyl, (dimethylamine)(tetramethyl-η⁵-cyclopentadienyl)dimethylsilytitanium (III) debenzyl, (diisobutylamine)(tetramethyl-η⁵-cyclopentadienyl)dimethylsilyltitanium (III) dimethyl, (diisopropylarnine)(tetramethyl-η⁵-cyclopentadienyl)dimethylsilyltitanium (III) dimethyl, (methyphenyllamine)(tetramethyl-η⁵-cyclopentadienyl)dimethylsilyltitanium (III) dimethyl, (1-methylethoxy)(tetramethyl-η⁵-cyclopentadienyl)dimethylsilanetitanium (III) dimethyl, 1 -(dimethylamine)-2-(tetramethyl-η⁵-cyclopentadienyl)-1,1,2,2-tetramethyldisilyltitanium (III) dimethyl, 1-(dimethylamine)-2-(tetramethyl-η⁵-cyclopentadienyl)-1,1,2,2-tetramethyldisilyltitanium (III) diallyl, 1-(dimethylamine)-2-(tetramethyl-η⁵-cyclopentadienyl)- 1,1,2,2-tetramethyldisilyltitanium (II) dibenzyl, 1-(diisobutylamine)-2-(tetramethyl-η⁵-cyclopentadienyl)-1,1,2,2-tetramethyldisilyltitanium (III) dimethyl, 1-(diisopropylamine)-2-(tetramethyl-η⁵-cyclopentadienyl)-1,1,2,2-tetramethyldisilyltitanium (III) dimethyl, 1-(methyphenyllamine)-2-(tetramethyl-η⁵-cyclopentadienyl)-1,1,2,2-tetramethyldisilyltitanium (III) dimethyl, 1-(dimethylamine)-2-(2,3-dimethyl-η⁵-indenyl)ethanediyltitanium (III) dimethyl, 1-(dimethylamine)-2-(2-methyl-il-indenyl)ethanediyltitanium (III) diallyl, 1-(dimethylamine)-2-(2,3,4,6-tetramethyl-η⁵-indenyl)ethanediyltitanium (III) dibenzyl, 1-(diisobutylamine)-2-(η⁵-indenyl)ethanediyltitanium (III) dimethyl, 1-(diisopropylamine)-2-(η⁵-cyclopentadienyl)ethanediyltitanium (III) dimethyl, 1-(methylphenylamine)-2-(η⁵-tetrahydroindenyl)ethanediyltitanium (III) dimethyl, (dimethylamine)(η⁵-tetrahydrofluorenyl)dimethylsilyltitanium (III) dimethyl, (dimethylamine)(η⁵-octahydrofluorenyl)dimethylsilyltitanium (III) diallyl, (dimethylamine)(2,3,4,6-tetramethyl-η⁵-indenyl)dimethylsilyltitanium (III) dibenzyl, (diisobutylamine)(2,3,4,6-tetramethyl-η⁵-indenyl)dimethylsilyltitanium (III) dimethyl, (diisopropylamine)(2,3,4,6-tetramethyl-η⁵-indenyl)dimethylsilyltitanium (III) dimethyl, (methylphenylamine)(2,3,4,6-tetramethyl-η⁵-indenyl)dimethylsilyltitanium (III) dimethyl, (1-methylethoxy)(2,3,4,6-tetramethyl-η⁵-indenyl)dimethylsilanetitanium (III) dimethyl, 1-(dimethylamine)-2-(2,3,4,6-tetramethyl-η⁵-indenyl)-1,1,2,2-tetramethyldisilyltitanium (III) dimethyl, 1-(dimethylamine)-2-(2,3,4,6-tetramethyl-η⁵-indenyl)-1,1,2,2-tetramethyldisilyltitanium (III) diallyl, 1-(dimethylamine)-2-(2,3,4,6-tetramethyl-η⁵-indenyl)-1,1,2,2-tetramethyldisilyltitanium (III) dibenzyl, 1-(diisobutylamine)-2-(2,3,4,6-tetramethyl-η⁵-indenyl)-1,1,2,2- tetramethyldisilyltitanium (III) dimethyl, 1-(diisopropylamine)-2-(2,3,4,6-tetramethyl-η⁵-indenyl)-1,1,2,2- tetramethyldisilyltitanium (III) dimethyl, and 1-(methyphenyllamine)-2-(2,3,4,6-tetramethyl-η⁵-indenyl)-1,1,2,2-tetramethyldisilyltitanium (III) dimethyl.

Complexes containing two L groups including bridged complexes suitable for use in the present invention include: bis(cyclopentadienyl)zirconium dimethyl, bis(cyclopentadienyl)zirconium dibenzyl, bis(cyclopentadienyl)zirconium methyl benzyl, bis(cyclopentadienyl)zirconium methyl phenyl, bis(cyclopentadienyl)zirconium diphenyl, bis(cyclopentadienyl)titanium allyl, bis(cyclopentadienyl)zirconium methyl methoxide, bis(cyclopentadienyl)zirconium methyl chloride, bis(pentamethylcyclopentadienyl)zirconium dimethyl, bis(pentamethylcyclopentadienyl)titanium dimethyl, bis(indenyl)zirconium dimethyl, indenylfluorenylzirconium dimethyl, bis(indenyl)zirconium methyl(2-(dimethylamino)benzyl), bis(indenyl)zirconium methyl trimethylsilyl, bis(tetrahydroindenyl)zirconium methyl trimethylsilyl, bis(pentamethylcyclopentadienyl)zirconium methyl benzyl, bis(pentamethylcyclopentadienyl)zirconium dibenzyl, bis(pentamethylcyclopentadienyl)zirconium methyl methoxide, bis(pentamethylcyclopentadienyl)zirconium methyl chloride, bis(methylethylcyclopentadienyl)zirconium dimethyl, bis(butylcyclopentadienyl)zirconium dibenzyl, bis(t-butylcyclopentadienyl)zirconium dimethyl, bis(ethyltetramethylcyclopentadienyl)zirconium dimethyl, bis(methylpropylcyclopentadienyl)zirconium dibenzyl, bis(trimethylsilylcyclopentadienyl)zirconium dibenzyl, dimethylsilyl-bis(cyclopentadienyl)zirconium dimethyl, dimethylsilyl-bis(tetramethylcyclopentadienyl)titanium (III) allyl dimethylsilylbis(t-butylcyclopentadienyl)zirconium dichloride, dimethylsilylbis(n-butylcyclopentadienyl)zirconium dichloride, (methylene-bis(tetramethylcyclopentadienyl)titanium (III)2-(dimethylamino)benzyl, (methylene-bis(n-butylcyclopentadienyl)titanium (III)2-(dimethylamino)benzyl, dimethylsilyl-bis(indenyl)zirconium benzyl chloride, dimethylsilyl-bis(2-methylindenyl)zirconium dimethyl, dimethylsilyl-bis(2-methyl-4-phenylindenyl)zirconium dimethyl, dimethylsilyl-bis(2-methylindenyl)zirconium (II)1,4-diphenyl-1,3-butadiene, dimethylsilyl-bis(2-methyl-4-phenylindenyl)zirconium (III)1,4-diphenyl-1,3-butadiene, dimethylsilyl-bis(tetrahydroindenyl)zirconium (III) 1,4-diphenyl-1,3-butadiene, dimethylsilyl-bis(fluorenyl)zirconium methyl chloride, dimethylsilyl-bis(tetrahydrofluorenyl)zirconium bis(trimethylsilyl), (isopropylidene)(cyclopentadienyl)(fluorenyl)zirconium dibenzyl, and dimethylsilyl(tetramethylcyclopentadienyl)(fluorenyl)zirconium dimethyl.

Other catalysts, especially catalysts containing other Group 4 metals, will, of course, be apparent to those skilled in the art.

Suitable addition polymerizable monomers include ethylenically unsaturated monomers, acetylenic compounds, conjugated or non-conjugated dienes, and polyenes. Preferred monomers include olefins, for examples alpha-olefins having from 2 to 20,000, preferably from 2 to 20, more preferably from 2 to 8 carbon atoms and combinations of two or more of such alpha-olefins. Particularly suitable alpha-olefins include, for example, ethylene, propylene, 1-butene,1-pentene,4-methylpentene-1, 1,1-hexene, 1-heptene, 1-octene, 1-nonene, 1-decene, 1-undecene, 1-dodecene, 1-tridecene, 1-tetradecene, 1-pentadecene, or combinations thereof, as well as long chain vinyl terminated oligomeric or polymeric reaction products formed during the polymerization, and C₁₀₋₃₀ π-olefins specifically added to the reaction mixture in order to produce relatively long chain branches in the resulting polymers. Preferably, the alpha-olefins are ethylene, propene, 1-butene, 4-methyl-pentene-1,1-hexene, 1-octene, and combinations of ethylene and/or propene with one or more of such other alpha-olefins. Other preferred monomers include styrene, halo- or alkyl substituted styrenes, tetrafluoroethylene, vinylcyclobutene, 1,4-hexadiene, dicyclopentadiene, ethylidene norbornene, 1,7-octadiene and 1,9-decadiene. Mixtures of the above-mentioned monomers may also be employed.

In general, the polymerization may be accomplished at conditions well known in the prior art for Ziegler-Natta or Kaminsky-Sinn type polymerization reactions. Suspension, solution, slurry, gas phase or high pressure, whether employed in batch or continuous form or other process conditions, may be employed if desired. Examples of such well known polymerization processes are depicted in WO 88/02009, US-A-5,084,534, US-A-5,405,922, US-A-4,588,790, US-A-5,032,652,. US-A-4,543,399, US-A-4,564,647, US-A-4,522,987, and elsewhere. Preferred polymerization temperatures are from 0-250° C. Preferred polymerization pressures are from atmospheric to 3000 atmospheres (100 kPa to 300 MPa).

However, the advantages of the invention are particularly noticed when the present catalyst system is used in a continuous solution polymerization in the presence of an aliphatic or alicyclic liquid diluent. Examples of such aliphatic or alicyclic liquid diluents include straight and branched-chain hydrocarbons such as isobutane, butane, pentane, hexane, heptane, octane, and mixtures thereof; alicyclic hydrocarbons such as cyclohexane, cycloheptane, methylcyclohexane, methylcycloheptane, and mixtures thereof; and perfluorinated hydrocarbons such as perfluorinated C₄₋₁₀ alkanes, and the like. Suitable diluents also include aromatic hydrocarbons (particularly for use with aromatic π-olefins such as styrene or ring alkyl-substituted styrenes) including toluene, ethylbenzene or xylene. Mixtures of the foregoing are also suitable.

In most polymerization reactions the molar ratio of catalyst:polymerizable compound employed is from 10^{31 12:}1 to 10^{31 1:}1,more preferably from 10^{31 12:}1 to 10^{31 5:}1,

The catalyst system of the invention may also be utilized in combination with at least one additional homogeneous or heterogeneous polymerization catalyst in the same reactor or in separate reactors connected in series or in parallel to prepare polymer blends having desirable properties. An example of such a process is disclosed in WO 94/00500, equivalent to U.S. Ser. No. 07/904,770. For purposes of U.S. patent practice, the teachings of all of the foregoing publications and pending applications are hereby incorporated by reference.

Molecular weight control agents can be used in combination with the present dispersed cocatalysts. Examples of such molecular weight control agents include hydrogen, trialkyl aluminum compounds or other known chain transfer agents. A particular benefit of the use of the present dispersed cocatalysts is the ability (depending on reaction conditions)to produce narrow molecular weight distribution a-olefin homopolymers and copolymers. Preferred polymers have Mw/Mn of less than 2.5, more preferably less than 2.3. Such narrow molecular weight distribution polymer products are highly desirable due to improved tensile strength properties as well as reduced levels of extractables.

It is understood that the present invention is operable in the absence of any component which has not been specifically disclosed. The following examples are provided in order to further illustrate the invention and are not to be construed as limiting. Unless stated to the contrary, all parts and percentages are expressed on a weight basis.

### Example 1-7

### Preparation of Dispersed Clay Cocatalyst

A sample of 15.0 g of K10 montmorillonite clay (available from Fluka, Corp.) was slurried in 100 ml of mixed hexanes and ground in a ball mill for 5 days. The average particle size D[v,0.5] of the clay after this procedure was measured and found to be 2.9 μm. The ground clay was collected on a fritted funnel, washed twice with 50 ml mixed hexanes, and dried under reduced pressure. The resulting clay was heated in air at 250° C. for 16 hours. In a nitrogen filled glove box, the recovered clay (13.6 g), was slurried in 100 mL mixed hexanes and 13 mL of a 1.9 M solution of triethylaluminum in toluene was slowly added. The slurry was agitated for 4 hours on a mechanical shaker. The solids were then collected on a fritted funnel, washed with two 50 mL portions of mixed hexanes, and dried under reduced pressure. A 1.50 g sample of the treated clay was slurried in 100 ml of mixed hexanes to provide a 0.015 g./ml suspension. The mixture was agitated for 3 hours to achieve a uniform suspension, then used as a cocatalysts in an olefin polymerization reaction.

### Polymerization

A stirred, one gallon (3.79 L) autoclave reactor was charged with about two liters of mixed alkanes solvent (Isopar™E) and 126 g of 1-octene. The reactor was heated to 130° C. and 2 psi (14 kPa) of hydrogen was added followed by sufficient ethylene to bring the total pressure to 450 psig (3100 kPa). The catalyst system was prepared in a drybox by combining together (tetramethylcyclopentadienyl)dimethyl(t-butylamido)silanetitanium dimethyl catalyst and the appropriate amount of clay with additional solvent to give a total volume of 17 mL. In addition to the modified clay material, triisopropylaluminum in a molar ratio of 10:1 based on metal complex was added to the catalyst system. Comparative activators comprising a mixture of tris(pentafluoropenyl)boron (FAB) and methylalumoxane (MAO) in 1:10 molar ratio were prepared in toluene solution as well. Between polymerizations the reactor was thoroughly rinsed with hot mixed hexanes.

The activated catalyst was injected into the reactor. The reactor temperature and pressure were maintained constant by continually feeding ethylene during the polymerization and cooling the reactor as required. After 10 minutes the ethylene was shut off and the hot solution transferred into a nitrogen purged resin kettle. An additive solution containing a phosphorus stabilizer and phenolic antioxidant (Irgaphos 168 and Irganox 1010 in toluene in a 2:1 weight ratio) was added to provide a total additive concentration of about 0.1 wt percent in the polymer. After drying the samples were weighed to determine catalyst efficiencies. The clay/ triisopropylaluminum mixtures were found to be active catalyst activators without the use of additional conventional cocatalysts. Results are contained in Table 1.

TABLE 1

| | Catalyst | Clay Dispersion | | Efficiency |
|---|---|---|---|---|
| Ex. # | (μmole) | (mL) | Cocatalyst | gPE/μgTi |
| A* | 1.2 | 0 | FAB/MAO** | 1.71 |
| 1 | 1.2 | 1 | — | 0.15 |
| 2 | 2.25 | 1 | — | 0.21 |
| 3 | 2.25 | 2 | — | 0.19 |
| 4 | 2.25 | 5 | — | 0.34 |
| 5 | 2.25 | 10 | — | 0.60 |
| 6 | 1.2 | 10 | — | 0.88 |
| B* | 1.2 | 0 | FAB/MAO** | 2.82 |

*Comparative, not an example of the invention
**FAB (1 μmole) + MAO (10 μmole)

What is claimed is:

1. A process for polymerization of an olefin comprising contacting one or more olefins in the presence of an inert aliphatic, alicyclic or aromatic hydrocarbon, with a catalyst composition comprising one or more Group 3-10 metal complexes, a dispersible clay catalyst activator comprising finely divided clay having a correlated settling rate less than 0.03 cm/sec, and optionally, from 0.001 to 10 mmol/g of clay of a Group 1 to 14 metal compound containing at least one alkyl group of up to 20 carbons, or an alumoxane.

2. A process according to claim 1 where the optional metal alkyl compound is described by the formula (R)₃Al where each R, independently each occurrence is selected from the group consisting of alkyl, aryl, amide, halogen, alkoxide, oxide, mercaptide, siloxane, or phosphide or up to 20 atoms not counting hydrogen, with the proviso that in at least one occurrence R is alkyl.

3. A process according to claim 1 wherein the catalyst composition comprises methylalumoxane.

4. A process according to claims 1-3 whereby the dispersible clay activator has a bulk density greater than about 0.2 g/mL.

5. The process of claims 1-3 wherein ethylene is homopolymerized or copolymerized with one or more C₃₋₁₀ π-olefins.

6. The process of claims 1-3 wherein propylene is homopolymerized or copolymerized with one or more C₂₋₁₀ π-olefins.

7. The process of claim 5 wherein ethylene and 1-octene are copolymerized.
